(19) United States
(12) Patent Application Publication
(10) Pub. No.: US 2003/0133015 A1
(43) Pub. Date: Jul. 17, 2003

(54) Web-connected interactive digital camera

(76) Inventors: Lawrence David Jackel, Holmdel, NJ (US); Frederick Kenneth Schmidt JR., Califon, NJ (US); Antony Van der Mude, Independence, NJ (US)

Correspondence Address: Samuel H. Dworetsky, AT&T CORP., P.O. Box 4110, Middletown, NJ, 07748-4110, US

(21) Appl. No.: 10/022,068

(22) Filed: Dec. 17, 2001

(51) Int. Cl. H04N 5/225

(52) U.S. Cl. 348/207.1

(57) ABSTRACT

An arrangement for capturing and transmitting a series of images, as well as associated sound clips, from a wireless digital camera to a network-based server for viewing at a web site by designated individuals. Text and/or audio messages from the viewers can be transmitted through the wireless packet network back to the digital camera, resulting in an interactive, bidirectional communication system between the camera user and the image viewers.

### TECHNICAL FIELD

The present invention relates to providing communication between digital camera owners and others using internet-based technology and, more particularly, to the use of a wireless interconnection between a digital camera and web server to create an environment for bidirectional communication between a digital camera owner and viewers of the camera images.

### BACKGROUND OF THE INVENTION

As the size and cost of electronic components continue to decrease, the popularity of digital electronic cameras which operate without using photographic film increases. In an exemplary digital camera, light reflected from a subject passes through a lens and strikes a digitizing device, such as a charge-coupled device (CCD) detector. The CCD detector, and associated circuitry, converts light rays into digital electronic signals that form an image of the subject. One or more digital images are stored in a solid-state memory device within the camera or in a removable memory device such as a flash memory card. The camera contains a microprocessor that executes the image formation and storage operations, under control of a computer program embodied in firmware such as read-only memory.

After a picture-taking session, the user of a conventional digital camera usually connects the camera to a personal computer to retrieve the images. Alternatively, the user may remove the memory device (e.g., flash memory card) and connect the card itself to a computer. The personal computer then executes a program that can read the stored images, either from the camera or the memory card, and show the images on a display of the personal computer. Under software control, the personal computer can also send one or more images to a printer, store the images as files on the personal computer, and carry out other functions, such as electronically sending the files to others.

One problem with this approach is that a user of the digital camera is required to use a computer to obtain a reasonable display of the digital images, as well as to print out a tangible copy of the picture; the camera cannot produce a printed copy itself. Another problem with this approach is the inherent time delay between taking the photograph and sharing it with others. That is, even if a photograph is taken with a digital camera, it still takes several hours to send the image to another person and receive a reply. Moreover, in most implementations, the user of a digital camera is required to use a personal computer in conjunction with the camera to send a digital image made with the camera to a distant friend, relative or neighbor. For all of these reasons, therefore, a need remains in the art to allow for the wider distribution, accessibility and faster publish/response times for the photographs taken with a digital camera.

### SUMMARY OF THE INVENTION

The needs remaining in the art are addressed by the present invention, which relates to providing communication between digital camera owners and others using internet-based technology and, more particularly, to the use of a wireless interconnection between a digital camera and web server to create an environment for bidirectional communication between a digital camera owner and viewers of the camera images.

In accordance with the present invention, a digital camera is modified to include a wireless modem for providing bidirectional communication between the digital camera and a defined web server (as controlled, in particular, by an EP address stored in the camera). A wireless connection is provided by an antenna and wireless transceiver within the camera, allowing for an audio message to be transmitted with the digital image from the camera to the designated website. Those wishing to view the images can then merely access the website by knowing the proper IP address or URL for the site. An additional feature of the present invention is the provision for transmitting a return message in real time from the viewer back to the user of the digital camera.

The system of the present invention can be configured for use in an “automated” mode so as to take a picture every few minutes (or seconds). This configuration is particularly useful in situations such as security monitoring of remote locations.

In an alternative embodiment of the present invention, a properly configured camera can be used to transmit streaming audio and video from the camera to the designated website, allowing viewers a near real-time method of viewing, responding to, and otherwise interacting with the camera user, regardless of his/her location.

Other and further embodiments of the present invention will become apparent during the course of the following discussion, and by reference to the accompanying drawings.

### BRIEF DESCRIPTION OF THE DRAWINGS

Referring now to the drawings,

FIG. 1 contains a rear elevation view of an exemplary digital camera incorporating the wireless communication system of the present invention;

FIG. 2 is an exemplary communication system architecture within which the system of the present invention may be used; and

FIG. 3 is an exemplary web page graphical user interface (GUI) that may be created using a photograph taken with a digital camera in association with the present invention.

### DETAILED DESCRIPTION

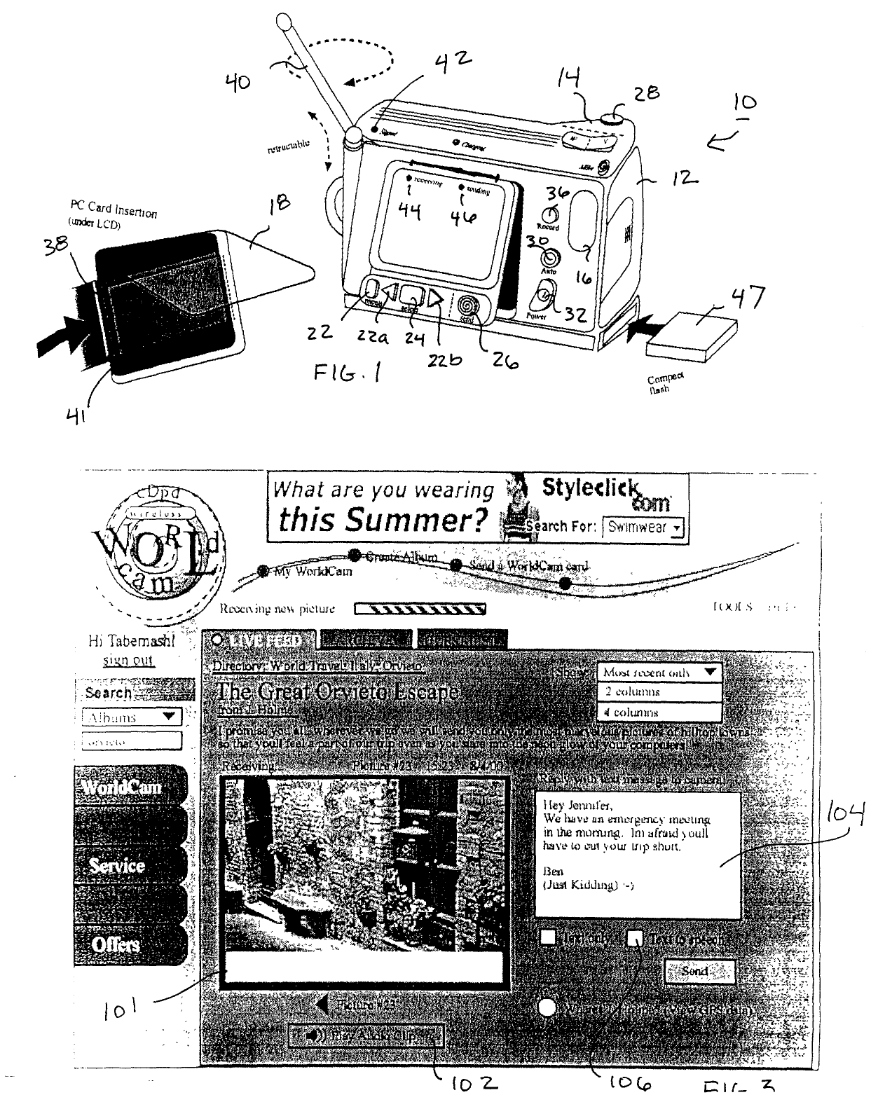

FIG. 1 contains a rear view of an exemplary wireless communication digital camera 10 formed in accordance with the present invention. Camera 10 comprises a body 12 generally formed as a rectangular box that can be held using, for example, a handgrip 14. A viewfinder 16 is optically coupled to a main lens (not shown), so that a user of the camera who wishes to take a photograph can look through viewfinder 16 to line up the shot.

A display device 18 is mounted on a hinge 20 along the backside of body 12 and is shown in its “open” position in FIG. 1. Stored images and camera settings may be viewed on display device 18, wherein one embodiment display device comprises a liquid crystal display (LCD) device. Selection buttons 22, 24 and 26 on display device 18 are used to step through a “menu” of options with the camera (button 22), select a particular image from a set of photographs taken with the camera (button 24), and transmit a selected image to the associated website (button 26), as will be discussed in detail below. Body 12 of camera 10 further includes a button 28 for actually taking a photograph, as well as an autofocus button 30 and power button 32. The photographs and other associated data may be stored in the camera's internal memory card 47.

A microphone 34 is included with camera 10 and used to record audio information that is stored with the digital image, where the recorded audio information can then be sent to designated website with the digital image. A record button 36 is used to turn “on” and “off” the recording of audio input through microphone 34. A modem card 38, such as for example a PC-MCIA (Personal computer Memory Card Industry Association) card, is used to store the recorded information and send the digitized information through a wireless communication network to an associated web server. As discussed below, modem card 38 utilizes any suitable type of wireless communication protocol for communication, via antenna 40, into a wireless packet network. One exemplary wireless protocol, Cellular Digital Packet Data (CDPD) is part of a commercially available service and is well-known to those skilled in the art. Other protocols that may be used include, but are not limited to, IEEE Standard 802.11, GPRS, GSM, CDMA and TDMA. Referring back to FIG. 1, retractable antenna 40 is mounted on body 12 of camera 10 and is used for providing communication between the wireless network and the digital camera. An indicator 42 is associated with antenna 40, and used to determine if sufficient signal strength exists between digital camera 10 and an associated wireless network.

In accordance with the teachings of the present invention, wireless digital camera 10 comprises a microprocessor 41, which interacts with modem card 38, and is used to control the operation of camera 10. In particular, microprocessor 41 functions to record and store the images and sound clips as digital, properly associating one with the other. Microprocessor 41 then compresses the digital image and sound digital data, preparing the data for transmission over the wireless modem link. Microprocessor 41 is configured to handle network access, including the send/receive protocol used by, for example CDPD transmission.

As mentioned above, an aspect of the arrangement of the present invention is the ability of a viewer of an image at the website to interact with the user of the digital camera. Included within display 18 of camera 10 are indicators 44 and 46, where indicator 44 is used to alert the camera user to “incoming” (received) information, and indicator 46 is used to confirm the transmission of audio and video information from camera 10 to the website. In accordance with the present invention, microprocessor 41 is able to receive this incoming information and form the alert signal displayed on camera 10. Under user control, an incoming message may be displayed on display 18, where the camera user may send replies to the incoming message by choosing one of a limited number of predetermined responses by using control buttons 22, 22a, 22b, 24 and 26.

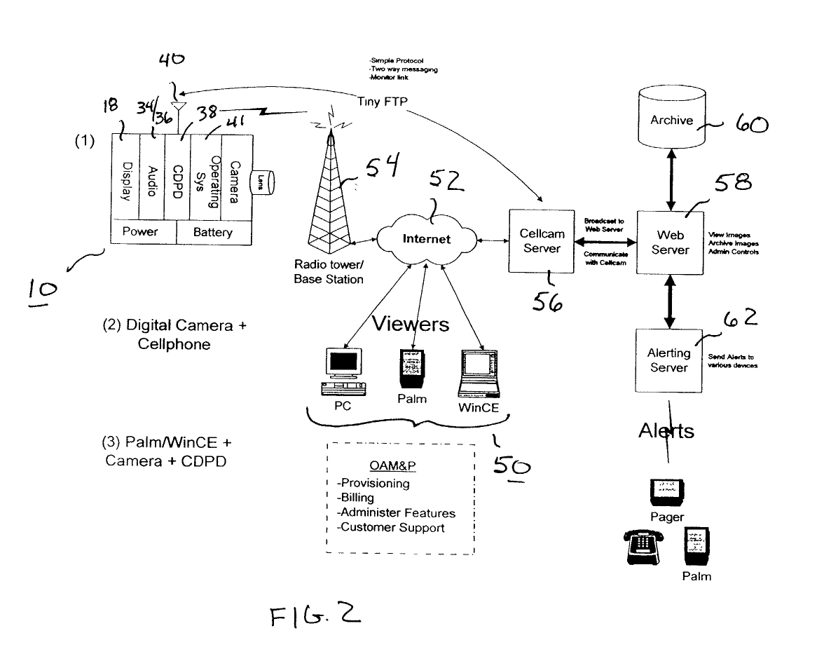

FIG. 2 illustrates an exemplary network arrangement that may be used to provide communication between a wireless digital camera 10 and a plurality of different viewers of the digital images, the viewers collectively designated by “50” in FIG. 2. It is to be understood that the system of the present invention is made secure by allowing only the owner of the wireless digital camera to designate a listing of potential viewers of the images. The viewer information (e.g., password, ID, etc.) is stored within microprocessor 41 and is transmitted along with the compressed images from camera 10 to the network elements used to display the images on a defined website. Referring to FIG. 2, communication between camera 10 and a digital network 52 (such as the Internet) is achieved through modem card 38, using CDPD, which is coupled to antenna 40. Antenna 40 then transmits the digital signal information (including both the video digital images and any recorded audio information) through a wireless base station 54 to digital network 52, The digital signal information is then routed by digital network 52 to a communication server 56, where server 56 is particularly configured to receive the digital image and audio information and convert this information into web-compatible information (using HTML, for example). By noting the particular IP address associated with the received information, communication server 56 will then forward the configured image and audio information to the designated web server 58. Web server 58 may include a database 60 for archiving the received information, allowing the archived information to be retrieved as needed.

Web server 58 also provides service administration functions for the camera owner. For example, the owner may log onto web server 58 to specify all kinds of administrative detail such as, but not limited to, the actual web display arrangement (see FIG. 3 for an example), creating and controlling an authorized list of image viewers, setting alert thresholds (as discussed below), archival specifications, and compilation of viewing statistics.

In accordance with the present invention, web server 58 also communicates with an alerting server 62, where alerting server 62 may be used to send a message to friends, relatives, etc. when updated images have been recorded by a particular digital camera. In operation, digital camera 10 may include the capability to record alerting information associated with companions of the user (e.g., paging number, email address, etc.). Each time video/audio information is transmitted by digital camera 10 through the wireless network to digital network 52, this “alerting” information is also transmitted. Upon recognizing the existence of alerting information at web server 58, this information is then transmitted to alerting server 62. Various devices within the set of devices 50 shown in FIG. 2 may then receive an “alert” that new information has arrived at the web server.

In another example of the alerting feature of the present invention, camera 10 may be set to record the same image over and over again. The alerting server is configured in this case (using the administrative features mentioned above) to search for any “significant” differences between sequentially received images in the series (i.e., a threshold number of bits that are different between sequentially received images). When such a difference is recognized by the server, an alert will then be sent to specified individuals (as defined in the administrative features). In one particular embodiment of the present invention, wireless digital camera 10 may be configured to continuously take pictures at a predetermined rate (e.g., a new picture every minute, or every 5 minutes, etc.) and automatically transmit the new picture through web server 58 to web page 100 (as shown in FIG. 3). This arrangement is particularly useful in security monitoring situations, where an individual viewing the web page is able to remotely observe the actions taking place at a particular location.

Regardless of whether the viewers are responding to an alert, or merely logging in to digital network 52, various devices 50 may be used to reach the web page and view one or more of the video images and associated audio information as recorded by the user of the digital camera. FIG. 3 illustrates an exemplary web page 100 that may be displayed by one of the devices 50. As shown, web page 100 includes a digital image 101 of a recent “picture” taken by digital camera 10. A hot button 102 is included on web page 100 and used to initiate the play of the recorded audio information (if any) supplied by the camera user. In accordance with the present invention, the system including digital camera 10 and web server 58 is “bidirectional”, meaning that a viewer of the web page may send a reply (or multiple replies) to the user of the camera. As shown in FIG. 3, web page 100 includes a text box 104 for allowing the viewer to type in a response that is then sent via the digital network and wireless network back to camera 10. If sent as text, the text will be shown on display area 18 of camera 10. An option 106 is included on the exemplary web page 100 to convert the typed text into “speech”. If this option is then selected, the converted speech is sent as an audio file to camera 10 and will be “played” for the camera user.

Obviously, numerous modifications and variations of the present invention are possible in light of the above teachings. It is therefore to be understood that within the scope of the appended claims, the invention may be practiced otherwise than as specifically defined herein.

What is claimed is:

1. An interactive digital electronic camera system comprising
a wireless digital electronic camera including
camera elements for capturing image information and digitizing the same for storing in a memory unit in said camera;
an audio element including a microphone and storage arrangement for recording audio input and speaker for playing received audio signals;
a microprocessor for storing recording images and audio information and associating one with the other, and processing and compressing the stored files for transmission; and
a wireless modem arrangement coupled to the microprocessor for transmitting compressed image and audio information over an associated wireless packet network to a defined network-based server and receiving incoming information for storage in said microprocessor;
a wireless communication link between said wireless digital electronic camera and a data communication network; and
a network-based server for communicating with said wireless digital electronic camera and configuring the received image and audio information for presentation to viewers, said network-based server retrieving web site address information from the received image and audio information and forwarding the received information to the defined web site.

2. The system as defined in claim 1 wherein the defined web site comprises an interactive web page allowing a viewer to input reply information forwarded to the wireless digital electric camera over the wireless communication link and received by the camera antenna and stored in the camera microprocessor.

3. The system as defined in claim 2 wherein the defined web site includes hot links to listen to audio files associated with the displayed image data.

4. The system as defined in claim 2 wherein the digital electronic camera includes a display element and the defined web site includes a dialog box for inputting a text response to be forwarded to the wireless digital electronic camera and presented on said camera display element.

5. The system as defined in claim 4 wherein the system includes a text-to-speech element for converting the text response into an audio file and transmitting the audio file to the wireless digital electronic camera, for playing by said camera using the speaker in the audio element.

6. The system as defined in claim 1 wherein the wireless modem comprises a cellular digital packet data (CDPD) PC-MCIA modem.

7. The system as defined in claim 1 wherein the microprocessor stores a listing of identification information associated with permitted viewers of the web site display.

8. The system as defined in claim 7 wherein the web server includes an authorization processor for checking the identification information of a potential viewer prior to allowing access to the defined web site.

9. The system as defined in claim 7 wherein the web server includes administrative feature capability to provide web display design, viewer authorization and statistical functionality.

10. The system as defined in claim 7 wherein the web server includes administrative feature capability to create an alert message when significant changes in sequential photographs of the same image occur.

11. The system as defined in claim 1 wherein the wireless digital electronic camera includes an automatic recording element to prompt the camera to record an updated image at a predetermined rate.

12. The system as defined in claim 11 wherein each updated image is automatically transmitted through the wireless packet network to the web server and replies are sent to the camera over the same wireless packet network.

13. The system as defined in claim 11 wherein the predetermined rate is sufficient to record an essentially streaming image signal.

14. The system as defined in claim 13 wherein the essentially streaming image signal is automatically transmitted through the wireless packet network to the web server.

15. The system as defined in claim 1 wherein the network-based server including an alert element for transmitting an alert signal to potential viewers when new image information is received.

16. An interactive wireless digital electronic camera including
camera elements for capturing image information and digitizing the same for storing in a memory unit in said camera;
a display element for showing both photographs taken by the wireless digital camera and textual replies received over a wireless packet network;
an audio element including a microphone and storage arrangement for recording audio input and speaker for playing received audio signals;
a microprocessor for storing recording images and audio information and associating one with the other, and processing and compressing the stored files for transmission; and
a wireless modem arrangement coupled to the microprocessor for transmitting compressed image and audio information over the wireless packet network to a defined network-based server and receiving incoming information for storage in said microprocessor.

17. The wireless digital electronic camera as defined in claim 16 wherein the camera includes a display element for displaying received text information from a viewer of camera images stored on the network-based server.

18. The wireless digital electronic camera as defined in claim 16 wherein the wireless modem comprises a wireless network protocol.

19. The wireless digital electronic camera as defined in claim 16 wherein the microprocessor stores a listing of identification information associated with permitted viewers of the transmitted images.

20. The wireless digital electronic camera as defined in claim 19 wherein said camera includes an automatic recording element to prompt said camera to record an updated image at a predetermined rate.

21. The system as defined in claim 20 wherein each updated image is automatically transmitted through the wireless packet network to the network-based server.

22. The system as defined in claim 20 wherein the predetermined rate is sufficient to record an essentially streaming image signal.

23. The system as defined in claim 22 wherein the essentially streaming image signal is automatically transmitted through the packet network to the network-based server.
